(19) United States
(12) Patent Application Publication
(10) Pub. No.: US 2023/0024309 A1
(43) Pub. Date: Jan. 26, 2023

(54) METHOD OF GENERATING POINT CLOUD PREDICTOR

(71) Applicant: INDUSTRIAL TECHNOLOGY RESEARCH INSTITUTE, Hsinchu (TW)

(72) Inventors: Jie-Ru LIN, Dongshan Township (TW); Ching-Chieh LIN, Hsinchu City (TW); Sheng-Po WANG, Taoyuan City (TW); Chun-Lung LIN, Taipei City (TW)

(73) Assignee: INDUSTRIAL TECHNOLOGY RESEARCH INSTITUTE, Hsinchu (TW)

(21) Appl. No.: 17/561,826

(22) Filed: Dec. 24, 2021

Related U.S. Application Data
(60) Provisional application No. 63/221,040, filed on Jul. 13, 2021.

(51) Int. Cl. H04N 19/597; H04N 19/105; H04N 19/176; H04N 19/463; H04N 19/167

(52) U.S. Cl. CPC H04N 19/597; H04N 19/105; H04N 19/176; H04N 19/463; H04N 19/167

(57) ABSTRACT

A method of generating point cloud predictor includes: obtaining an encoding unit, wherein the encoding unit is generated from a current three-dimensional (3D) image, obtaining a current 3D block in the current 3D image according to the encoding unit, obtaining a reference 3D block in a reference 3D image according to the current 3D block, wherein the reference 3D image is associated with the current 3D image, obtaining a reference two-dimensional (2D) unit in a reference 2D image according to the reference 3D block, wherein the reference 2D image is generated from the reference 3D image, and generating and outputting a predictor according to a variation degree between the encoding unit and the reference 2D unit.

### TECHNICAL FIELD

This disclosure relates to a method of generating point cloud predictor.

### BACKGROUND

Point cloud is a set of irregular points in a three-dimensional (3D) space, and may represent a 3D shape or object, wherein there may be no connection between points. Point cloud is usually composed of 3D coordinates (for example, coordinates of X, Y and Z axes), and each point may represent a location at one surface of an object. Except for 3D coordinate, point cloud may also further include attribute, such as the color components (R, G, B) or (Y, U, V), for presenting the color of the object.

According to the state-of-the-art compression technology, before generating a bit stream, the 3D point cloud is projected onto one of the 2D surface of a hexahedron to generate a plurality of patches, these patches are arranged in a two-dimensional (2D) video frame, then the encoder starts performing encoding process. When arranging the patches in the 2D video frame, the patches are usually sorted in descending order based on the sizes of each patch. Then, the arranging process starts from the top-left corner of the video to sequentially place each patch to a proper or available location. However, the amount and the sizes of the patches vary from frame to frame, so the patch arrangement of each frame may be quite different, which destroys the temporal continuity. When coding with the inter-prediction to search for a predictor in temporal neighborhood, a truly accurate candidate could not be obtained and therefore the coding efficiency will be degraded, even if there are similar patches in current coding frame and reference frame. If a global search approach is used to obtain the accurate predictor, the coding complexity and coding time would be dramatically boosted.

### SUMMARY

Accordingly, the present disclosure provides a method of generating point cloud predictor that meets the above requirements.

According to one or more embodiments of this disclosure, a method of generating point cloud predictor, comprises: obtaining an encoding unit; and generating and outputting a predictor according to a variation degree between the encoding unit and a reference two-dimensional (2D) unit.

According to one or more embodiments of this disclosure, a method of generating point cloud predictor comprises: obtaining an encoding unit; obtaining a first variation degree between a current projection box and a reference projection box according to the encoding unit; obtaining a second variation degree between a current bounding box and a reference bounding box according to the encoding unit; and outputting a predictor based on a sum of the first variation degree and the second variation degree.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flow chart illustrating a method of generating point cloud predictor according to an embodiment of the present disclosure;

FIGS. 2a to 2d are schematic diagrams illustrating a method of generating point cloud predictor according to an embodiment of the present disclosure;

FIG. 3A is a flow chart illustrating a method of generating point cloud predictor according to another embodiment of the present disclosure;

FIG. 3B is a flow chart illustrating a method of generating point cloud predictor according to yet another embodiment of the present disclosure;

FIG. 4 is a flow chart illustrating a method of generating point cloud predictor according to still another embodiment of the present disclosure;

FIGS. 5a to 5d are schematic diagrams illustrating a method of generating point cloud predictor according to an embodiment of the present disclosure; and

FIG. 6 is a flow chart illustrating a method of generating point cloud predictor according to yet still another embodiment of the present disclosure

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

The method of generating point cloud predictor of the present disclosure is performed before an encoder outputting a bit stream to a decoder, and is performed during the decoder decoding the bit stream to reconstruct a video. Therefore, through the method of generating point cloud predictor of the present disclosure, when the decoder is decoding the video, a more accurate predicted unit or predicted block may be obtained. It should be noted that, one three-dimensional (3D) image frame may be used to generate a plurality of two-dimensional (2D) patches, and “unit” herein indicates a part of one 2D patch, “unit” herein may also indicate one complete 2D patch or a plurality of 2D patches; “block” indicates a part of the 3D image (one 3D block), “block” may also indicate one complete 3D image frame.

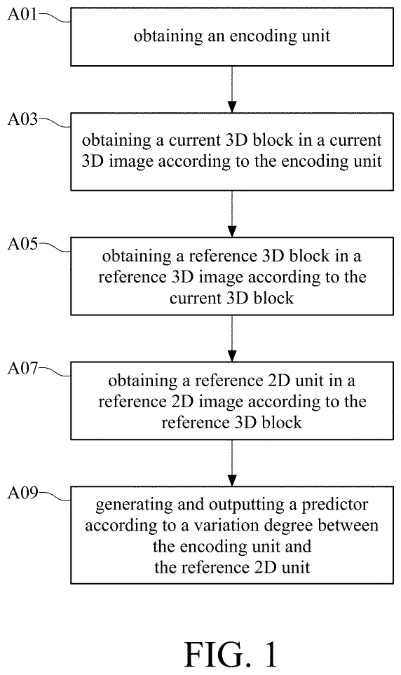

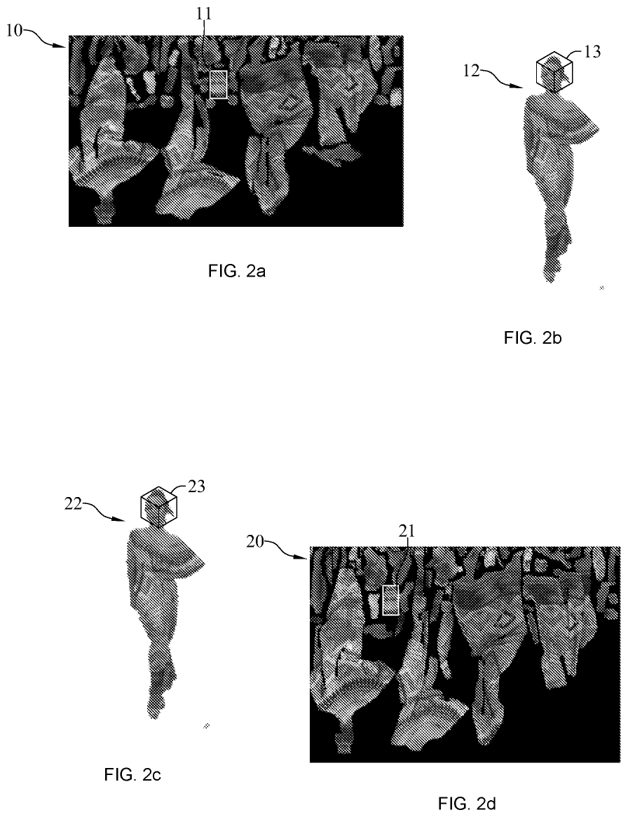

The method of generating point cloud predictor of the present disclosure may be performed by the encoder device and the decoder device, and is preferably performed by a processor, server or other computing device of the encoder and the decoder. The present disclosure does not limit the hardware device performing the method of generating point cloud predictor. For better illustration, the following description uses processors at the encoder site and the decoder site as the hardware device performing the method of generating point cloud predictor of the present disclosure. Please refer to FIG. 1 and FIGS. 2a to 2d. FIG. 1 is a flow chart illustrating a method of generating point cloud predictor according to an embodiment of the present disclosure; FIGS. 2a to 2d are schematic diagrams illustrating a method of generating point cloud predictor according to an embodiment of the present disclosure. Steps A03, A05 and A07 shown in FIG. 1 may be steps that are selectively performed; FIGS. 2b and 2c are 3D images that are similar to each other but are not completely the same with each other. For example, FIGS. 2b and 2c may be 3D images of different frames in the time domain.

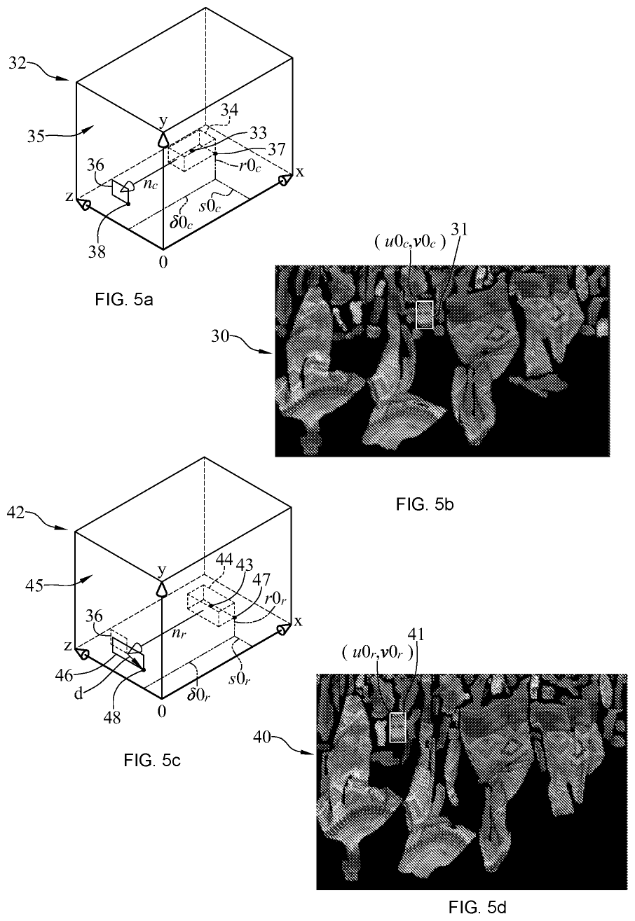

In step A01, the processor obtains an encoding unit 11. The processor obtains encoding unit 11 of a current 2D image 10, wherein the current 2D image 10 is generated from a current 3D image 12. Specifically, the method of the processor obtaining the current 2D image 10 may be projecting the current 3D image 12 onto a surface of an imaginary hexahedron to generate a plurality of patches, and packing the patches into a 2D frame to generate the current 2D image 10. Said encoding unit 11 is the unit to be encoded locating in the current 2D image 10. Said unit may be a basic unit of high efficiency video coding (HEVC), said unit may also be a center pixel in the basic unit. The processor may obtain the coordinate (for example, the coordinate (u0_{c}, v0_{c}) shown in FIG. 5b) representing each unit in the patches, the processor may also obtain the coordinate (for example, the coordinate (u0_{c}, v0_{c}) shown in FIG. 5b) representing the encoding unit 11 after determining that the encoding unit 11 in the patches is the unit need to be encoded.

Then, in step A03, the processor obtains a current 3D block 13 in the current 3D image 12 according to the encoding unit 11, wherein said “block” is a stereoscopic block. The current 3D image 12 may be an image of one of the frames of a 3D video, and the current 3D block 13 is the stereoscopic block in the current 3D image 12 corresponding to the encoding unit 11. Since the current 2D image 10 may be patches (or a part of a patch) deconstructed from the current 3D image 12 (deconstructed through projection), the processor may obtain the current 3D block 13 in the current 3D block 13 that the encoding unit 11 corresponds to according to the 2D encoding unit 11.

Specifically, the processor may pre-store a corresponding relationship between each block of the current 3D image 12 and each unit of the current 2D image 10, the processor may perform step A03 in a look-up table manner. More specifically, when generating packed patches based on the current 3D image 12, the processor may establish or update a group of coordinate conversion parameters, the group of coordinate conversion parameters records a corresponding relationship between a coordinate of a unit in each 2D patch and a coordinate of each block of the current 3D image 12. Therefore, in step A03, the processor may determine one of the units of the group of coordinate conversion parameters that is the same as the encoding unit 11, and use the block corresponding to the unit that is the same as the encoding unit 11 as the current 3D block 13. In short, in step A03, the processor may determine the current 3D block 13 according to the encoding unit 11 and the group of coordinate conversion parameters.

In step A05, the processor obtains a reference 3D block 23 in a reference 3D image 22 according to the current 3D block 13, wherein the reference 3D image 22 is associated with the current 3D image 12, and the reference 3D image 22 is an encoded image. Said “the reference 3D image 22 is associated with the current 3D image 12” may indicate that the reference 3D image 22 and the current 3D image 12 are images of different frames in the same 3D video; said “the reference 3D image 22 is associated with the current 3D image 12” may indicate that a similar object may appear in the reference 3D image 22 and the current 3D image 12 or may have at least one identical object in the reference 3D image 22 and the current 3D image 12 (for example, the person in FIGS. 2b and 2c); said “the reference 3D image 22 is associated with the current 3D image 12” may also indicate that the reference 3D image 22 and the current 3D image 12 are images of different frames in the same 3D video, and that a similar object of at least one identical object may appear in these two frames of images. For example, the reference 3D image 22 may be the previous image frame or the next image frame of the current 3D image 12 in temporal domain, or there may be a plurality of images between the reference 3D image 22 and the current 3D image 12. Specifically, the processor may determine the reference 3D block 23 in this reference 3D image 22 through rate—distortion optimization (RDO) or coder and decoder (CODEC) optimization instead of other reference 3D images.

After determining the reference 3D block 23, in step A07, the processor obtains a reference 2D unit 21 in a reference 2D image 20 according to the reference 3D block 23, wherein the reference 2D image 20 and the current 2D image 10 are different image. In detail, the reference 2D image 20 is the corresponding image previously generated by the processor by projecting the reference 3D image 22, the method of generating the reference 2D image 20 may be the same as that of the current 2D image 10. Therefore, the processor may have another group of coordinate conversion parameters, which records a corresponding relationship between a coordinate of a unit of each 2D patch in the reference 2D image 20 and a coordinate of each block of the reference 3D image 22. Therefore, in step A07, the processor may determine the reference 2D unit 21 according to the reference 3D block 23 based on said another group of coordinate conversion parameters. That is, the processor selects the reference 2D image 20 from the pre-generated one or more reference 2D images.

In addition, the reference 2D image 20 may include a plurality of invalid units and a plurality of valid units, and these invalid units and valid units may be recorded in an occupancy map. Specifically, the invalid unit indicates an area not disposed with a patch in the reference 2D image 20, and the valid unit indicates an area disposed with a patch in the reference 2D image 20. In the reference 2D image 20, the unit located in the patch is a valid unit, and the corresponding bit of the unit may be set as “1”; and the unit in the reference 2D image 20 located outside of patches is an invalid unit, and the corresponding bit of the unit may be set as “0”. Therefore, the processor may enclose the valid units in the reference 2D image 20 according to the occupancy map. Then, the processor may select one of the valid units as the reference 2D unit 21, wherein the reference 3D block 23 corresponds to a unit in the reference 3D block 23, and the selected valid unit is the closest one to said unit among the valid units.

Subsequently, in step A09, the processor generates and outputs a predictor according to a variation degree between the encoding unit 11 and the reference 2D unit 21, wherein the variation degree between the encoding unit 11 and the reference 2D unit 21 may include a degree of movement or a degree of variation between the encoding unit 11 and the reference 2D unit 21. In addition, if the encoding unit 11 and the reference 2D unit 21 further include attribute coordinates such as the color components (R, G, B) or (Y, U, V), the variation degree between the encoding unit 11 and the reference 2D unit 21 may further include the differences between these attribute coordinates. The predictor may be outputted to a memory for storage, the present disclosure does not limit the subject of the processor outputting the predictor. Assuming the encoding unit 11 is represented by the coordinate (x_{c}, y_{c}), and the reference 2D unit 21 is represented by the coordinate (xᵣ, yᵣ), the predictor may be obtained through the following equation (1), wherein the predictor represents the displacement between the encoding unit 11 and the reference 2D unit 21.

predictor=(xᵣ,yᵣ)−(x_{c},y_{c}) equation (1)

Specifically, since the current 3D image 12 and the reference 3D image 22 are 3D images of different frames but are associated with each other, the same object may exist in the current 3D image 12 and the reference 3D image 22 and may be presented in different postures. Under this circumstance, the shapes and the arranged positions of the patches in the current 2D image 10 and the reference 2D image 20 may not be exactly the same for to dispose the patches into a smaller space, thereby generating the current 2D image 10 and the reference 2D image 20 that are associated with each other but are not exactly the same. That is, a unit/patch in the current 2D image 10 may be similar to a unit/patch in the reference 2D image 20, but one unit/patch in may be located in the center of the current 2D image 10, and the other unit/patch in may be located at the left side of the reference 2D image 20. By generating the predictor, even if units of an object locate at different positions in the current 2D image 10 and the reference 2D image 20, or even if shapes of units of an object in the current 2D image 10 and the reference 2D image 20 are not exactly the same, the decoder may still determine the encoding unit 11 in the current 2D image 10 and the reference 2D unit 21 in the reference 2D image are indicating the same object through the predictor. Accordingly, when decoding a video, the relationships of each unit (or patch) between frames may be determined.

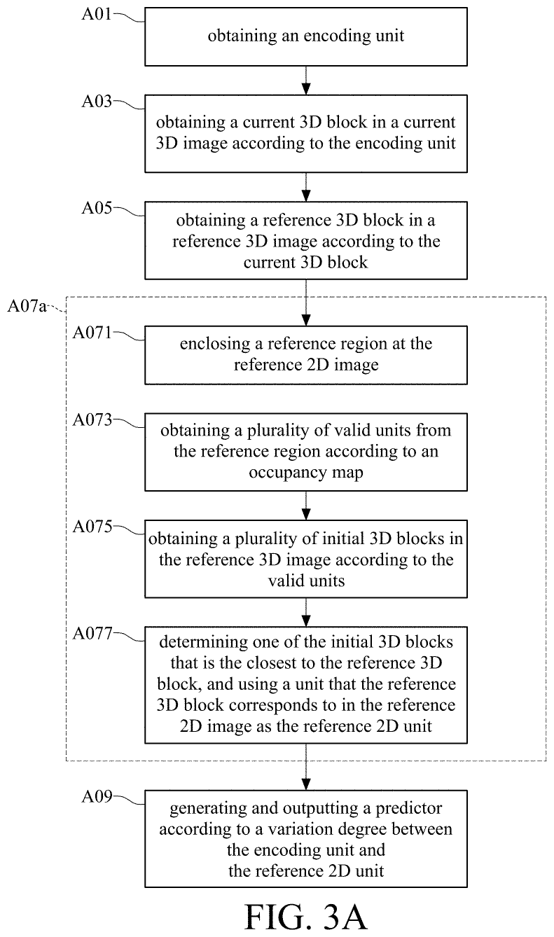

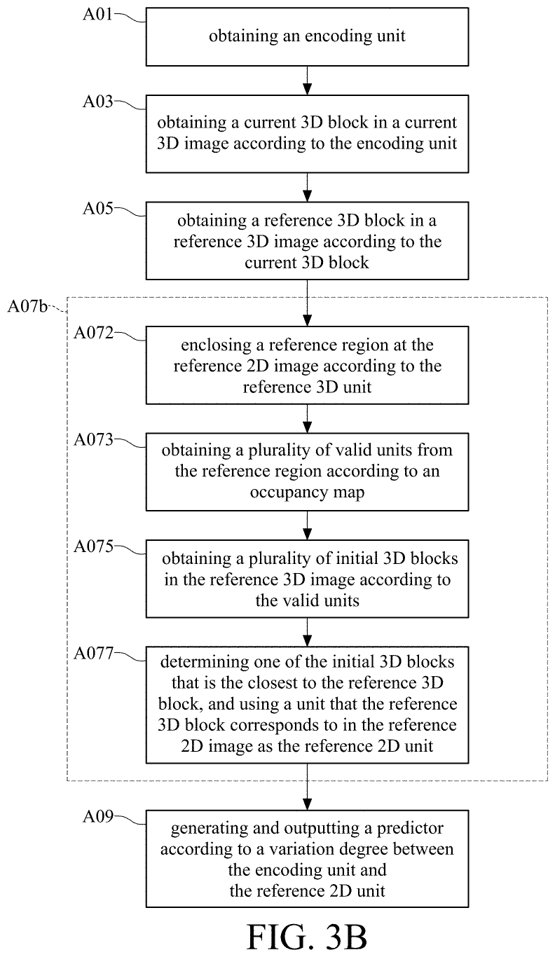

Please refer to FIGS. 2a to 2d and FIG. 3A. FIG. 3A is a flow chart illustrating a method of generating point cloud predictor according to another embodiment of the present disclosure. Comparing to the embodiment of the method of generating point cloud predictor illustrated in FIG. 1, the embodiment shown in FIG. 3A replaces step A07 shown in FIG. 1 with step A07a. In detail, in this embodiment which includes step A07a, after the processor performing step A05 to obtain the reference 3D block 23, the processor performs step A071 to enclose a reference region in the reference 2D image 20, and a size of the reference region is preferably smaller than a size of the reference 2D image 20. The size of the reference region may be larger than the encoding unit 11 by several times. For example, an area of the reference region may be 2 times, 3 times, etc. of an area of the encoding unit 11, the present disclosure does not limit the actual area of the reference region. Accordingly, even if the initial reference 2D unit is not accurate enough, the processor may still find a reference 2D unit in the reference region which the size and the content is similar with the encoding unit 11. The reference region includes a plurality of invalid units and a plurality of valid units, wherein the reference 2D unit 21 may be one of the valid units. Similar to the above, the invalid units and the valid units in the reference region may be recorded in the occupancy map. The difference between the occupancy map of step A071 and the occupancy map of step A07 of FIG. 1 lies in that, the occupancy map in step A071 only utilize the invalid units and the valid units in the reference region, and the occupancy map of step A07 of FIG. 1 records the invalid units and the valid units of the entire the reference 2D image 20. In addition, in step A071, the valid units recorded in the occupancy map not only include the units within the reference region, but further include the units located on the boundary of the reference region.

Then, in step A073, the processor selects the valid units from the reference region according to the occupancy map; and in step A075, the processor obtains a plurality of initial 3D blocks in the reference 3D image 22 according to the valid units. After selecting valid units, the processor may also obtain a corresponding block of each valid unit in the reference 3D image 22, to use the obtained corresponding block as the initial 3D block, wherein the corresponding block may be obtained in the look-up table manner using the group of coordinate conversion parameters.

Then, in step A077, the processor may calculate difference values (for example, distance) between each of the initial 3D blocks and the reference 3D block 23, determine one of the initial 3D blocks that is the closest to the reference 3D block 23, and use the unit in the reference 2D image 20 corresponding to the initial 3D block as the reference 2D unit 21.

Specifically, if the coordinate representing the reference 3D block 23 is (x₃ᵣ, y₃ᵣ, z₃ᵣ); and the coordinate representing the initial 3D block is (x_{3r′}, y_{3r′}, z_{3r′}), the processor may calculate the difference values between each of the initial 3D blocks and the reference 3D block 23 by equation (2) below.

difference value=(x₃ᵣ−x_{3r′})²+(y₃ᵣ−y_{3r′})²+(z₃ᵣ−z_{3r′})² equation (2)

After the processor calculating the difference values between each of the initial 3D blocks and the reference 3D block 23, the processor may select the initial 3D block with the smallest difference value. Then, the processor may determine the unit corresponding to the initial 3D block in the reference 2D image 20 through the group of coordinate conversion parameters, and use the unit as the reference 2D unit 21. Accordingly, in step A09, the processor may use the difference between the encoding unit 11 and the reference 2D unit 21 as the predictor. Through this embodiment, since the processor does not need to perform a global search on the reference 2D image 20 to find the unit that is the closest to the encoding unit 11, the searching efficiency may be effectively improved, and the amount of computation performed by the processor may be reduced.

Please refer to FIGS. 2a to 2d and FIG. 3B. FIG. 3B is a flow chart illustrating a method of generating point cloud predictor according to yet another embodiment of the present disclosure. Comparing to the embodiment of the method of generating point cloud predictor illustrated in FIG. 3A, the embodiment shown in FIG. 3B replaces step A07a shown in FIG. 3A with step A07b. In detail, after the processor performing step A05 to obtain the reference 3D block 23, the processor performs step A072, which is enclosing the reference region in the reference 2D image 20 according to the reference 3D block 23, wherein the reference region also includes a plurality of invalid units and a plurality of valid units. The valid units preferably include a unit corresponding to the reference 3D block 23 in the reference 2D image 20. Specifically, in step A072, the processor obtains an initial predicted reference region according to the reference 3D block 23, and one of the units in the reference region may be a potential reference 2D unit 21. After enclosing the reference region, the processor may then perform step A073 and the following steps. Through this embodiment, not only the reference 2D unit 21 is made sure to be located in the reference region, the processor only needs to calculate a distance between a block corresponding to the reference region and the reference 3D block. Therefore, the method of generating point cloud predictor of the present disclosure may improve searching efficiency, the amount of computation performed by the processor may be reduced, and a more accurate reference 2D unit 21 may be obtained.

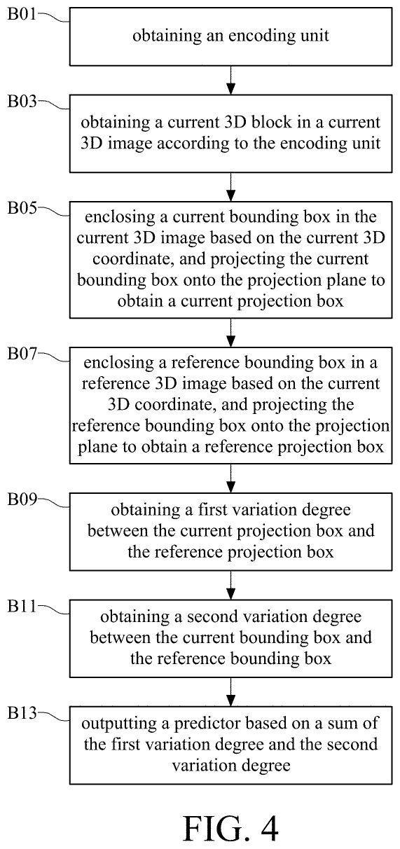

Please refer to FIG. 4 and FIGS. 5a to 5d. FIG. 4 is a flow chart illustrating a method of generating point cloud predictor according to still another embodiment of the present disclosure; FIGS. 5a to 5d are schematic diagrams illustrating a method of generating point cloud predictor according to an embodiment of the present disclosure. Similar to the description of FIGS. 2b and 2c, FIGS. 5b and 5c are 3D images similar to each other but are not the same with each other. The difference between the embodiment of FIG. 4 and the embodiments of FIG. 1, FIGS. 3A and 3B is that, FIG. 1 and FIGS. 3A and 3B determine the reference 2D unit that is the closest to the encoding unit in a point-to-point manner, and FIG. 4 determines the reference block that is the closest to the encoding unit in a patch-to-patch manner, wherein steps B03, B05 and B07 in FIG. 4 may be steps selectively performed. Further, for better understanding, FIGS. 5a and 5b present 3D images and 3D patches described below in a form of a cube, but the actual appearances of 3D images and 3D patches are the appearances of the object(s) in the video (as shown in FIGS. 2a to 2d).

Similar to the above description, when the processor obtains the current 3D image, the processor may project the current 3D image onto a surface of an imaginary hexahedron to generate a plurality of patches, and pack the patches to a 2D frame to generate the current 2D image 30. Same as step A01 of FIG. 1, in step B01 of FIG. 4, the processor obtains the encoding unit 31 of the current 2D image 30, wherein the current 2D image 30 is generated from a current 3D image 32.

In step B03, the processor obtains a current 3D coordinate 33 in the current 3D image 32 according to the encoding unit 31. Specifically, one vertex coordinate of the encoding unit 31 is (u0_{c}, v0_{c}), the coordinate representing the internal of the encoding unit 31 is (x, y), and the current 3D coordinate 33 may be obtained through equation (3) below.

$$\{ \begin{matrix}x 3 = δ {0}_{c} + h ( x , y ) \\ y 3 = y - v {0}_{c} \times b p r + r 0 \\ z 3 = x - u {0}_{c} \times b p r + s 0\end{matrix} \qquad equation ( 3 )$$

wherein, (x3, y3, z3) is the current 3D coordinate 33; (δ0_{c}, s0_{c}, r0_{c}) represents a location of a current bounding box 34 in the current 3D image 32, and 60 is a distance of the current bounding box 34 in the current 3D image 32 from the projection plane; h(x, y) is a depth of an internal point coordinate (x, y) of the encoding unit 31; bpr is a resolution of the encoding unit 31.

Then, in step B05, the processor encloses the current bounding box 34 in the current 3D image 32 according to the current 3D coordinate 33, and projects the current bounding box 34 onto the first projection plane 35 to obtain the current projection box 36. The current projection box 36 is the encoding unit 31, and the coordinate parameter of the current projection box 36 on the first projection plane 35 is the coordinate parameter of the encoding unit 31 in the current 2D image 30. The processor may further determine the space parameter of the current bounding box 34 in the current 3D image 32, which includes n_{c}, (u0_{c}, v0_{c}) and (δ0_{c}, s0_{c}, r0_{c}). (δ0_{c}, s0_{c}, r0_{c}) represents the location (the location of the current positioning point 37) of the current bounding box 34 in the current 3D image 32; n_{c} represents the normal vector of the current bounding box 34; (u0_{c}, v0_{c}) represents the coordinate of the current projection point 38 of the current projection box 36. The current projection point 38 is the projection point of the current positioning point 37 on the first projection plane 35. In addition, in step B05, the processor uses space occupied by the encoding unit 31 in the current 3D image 32 as the range of the current bounding box 34. That is, different encoding units may correspond to the bounding boxes with different sizes. Therefore, the processor may not need to additionally set the range of the current bounding box 34, and the current bounding box 34 may fit the actual size of the encoding unit 31 in the current 3D image 32.

Then, in step B07, the processor obtains the reference bounding box 44 from the reference 3D image 42 according to the current 3D coordinate 33, and projects the reference bounding box 44 onto the second projection plane 45 to obtain the reference projection box 46. The reference projection box 46 is a reference unit 41, the coordinate parameter of the reference projection box 46 on the second projection plane 45 is the coordinate parameter of the reference unit 41 in the reference 2D image 40, and the reference 2D image 40 is generated by the patches of the reference 3D image 42. Same as the above description of the current 2D image 10 and the reference 2D image 20, since the same object may be presented in different appearance in the current 3D image 32 and the reference 3D image 42, for the shapes and arranged locations of the patches in the reference 2D image 40 and the current 2D image 30 may not be exactly the same. Therefore, the reference 2D image 40 and the current 2D image 30 are images of different frames but are associated with each other. To be more specific, the processor may use the current 3D block 33 as a reference 3D coordinate 43 in the reference 3D image 42, and obtains the reference bounding box 44 according to the reference 3D coordinate 43. In other words, the reference bounding box 44 includes the reference 3D coordinate 43, and the reference 3D coordinate 43 in the reference 3D image 42 is preferably the same as the current 3D coordinate 33 in the current 3D image 32. Further, the normal vector nᵣ of the reference bounding box 44 is preferably the same as the normal vector n_{c} of the current bounding box 34. Since the reference bounding box 44 is generated based on the information related to the current 3D coordinate 33, a reference positioning point 47 of the reference bounding box 44 corresponds to the current positioning point 37, and the processor may determine a space parameter of the reference bounding box 44 in the reference 3D image 42. The space parameter of the reference bounding box 44 includes the normal vector nᵣ and further includes (u0ᵣ, v0ᵣ) and (δ0ᵣ, s0ᵣ, r0ᵣ), wherein (δ0ᵣ, s0ᵣ, r0ᵣ) represents the location of the reference bounding box 44 in the reference 3D image 42 (i.e. the location of the reference positioning point 47); (u0ᵣ, v0ᵣ) represents the coordinate of the reference projection point 48 of the reference projection box 46. It should be noted that, the first projection plane 35 and the second projection plane 45 are substantially the same. That is, the current bounding box 34 and the reference bounding box 44 may project onto the same projection plane, the current bounding box 34 and the reference bounding box 44 may also project onto the first projection plane 35 and the second projection plane 45 which are parallel to each other.

After obtaining the location (δ0_{c}, s0_{c}, r0_{c}) of the current bounding box 34, the location (u0_{c}, v0_{c}) of the current projection point 38, the location (δ0ᵣ, s0ᵣ, r0ᵣ) of the reference bounding box 44 and the location (u0ᵣ, v0ᵣ) of the reference projection point 48, the processor may continue to perform step B09. In step B09, the processor calculates a first variation degree d between the location (u0_{c}, v0_{c}) of the current projection point 38 and the location (u0ᵣ, v0ᵣ) of the reference projection point 48. Since the current bounding box 34 and the reference bounding box 44 may be similar to each other but are not exactly the same as each other, even the current projection box 36 and the reference projection box 46 are similar to each other, an error may still exist between the current projection box 36 and the reference projection box 46. Further, since the current projection box 36 and the reference projection box 46 are similar to each other, the processor may calculate the first variation degree d according to the corresponding points of the current projection box 36 and the reference projection box 46. The processor may perform step B09 through equation (4) below.

the first variation degree=(u0ᵣ−u0_{c},v0ᵣ−v0_{c})×bpr equation (4)

In step B11, the processor calculates a second variation degree (not shown) between the current positioning point 37 of the current bounding box 34 and the reference positioning point 47 of the reference bounding box 44. Similarly, since the current bounding box 34 and the reference bounding box 44 are similar to each other, the processor may determine the current positioning point 37 and the reference positioning point 47 corresponding to each other, and use a difference between the current positioning point 37 and the reference positioning point 47 as the second variation degree. The processor may perform step B11 through equation (5) below.

the second variation degree=(r0_{c}−r0ᵣ,s0_{c}−s0ᵣ) equation (5)

It should be noted that, step B09 and step B11 may be performed simultaneously, step B11 may also be performed before step B09, the present disclosure does not limit the sequence of step B09 and step B11.

After calculating the first variation degree d and the second variation degree, in step B13, the processor uses a sum of the first variation degree d and the second variation degree as the predictor, and outputs the predictor. Accordingly, after the decoder receiving the bit stream, the processor may select the reference 2D unit 41 (i.e. the reference projection box 46) that relates the most with the encoding unit 31 (i.e. the current projection box 36) according to the predictor.

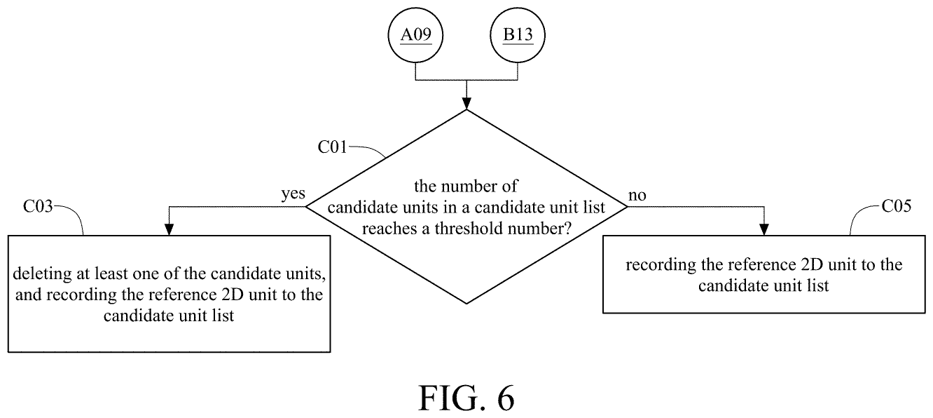

Please refer to FIGS. 2a to 2d and FIG. 6. FIG. 6 is a flow chart illustrating a method of generating point cloud predictor according to yet still another embodiment of the present disclosure. To avoid obscuring the focus of the embodiment of FIG. 6, FIG. 6 only illustrates steps C01, C03 and C05, wherein steps C01, C03 and C05 of FIG. 6 may be performed after step A09 of FIG. 1 and FIGS. 3A, 3B, steps C01, C03 and C05 may also be performed after step B13 of FIG. 4.

It should be noted that, when the processor performs encoding/decoding of a merge mode, the processor may pre-store a candidate list. The candidate list records a plurality of indexes of indicating the candidate units, and the processor may determine the corresponding candidate predictor according to the index, wherein the index may include the coordinate, appearance and attribute coordinate of the candidate unit. The candidate unit and the corresponding candidate predictors may include the candidate unit and the candidate predictor generated through steps A09, B13, the candidate unit and the corresponding candidate predictors may also include a merged candidate unit determined spatially and temporally (merging candidates). The candidate unit is the unit in the reference 2D image 20/40 that is similar to the encoding unit 11/31, each candidate unit may indicate the same unit (or the same patch) as the reference 2D unit 21/41 in the reference 2D image 20/40. The candidate predictor represents a degree of displacement between a current encoding basic unit and the reference 2D unit determined from the candidate unit.

For example, a candidate unit list may be presented as below table 1. In short, the candidate unit list records every candidate unit and the corresponding index, and the corresponding candidate predictor of every candidate unit may be determined according to the index of the candidate unit. The candidate units are preferably units that are spatially adjacent to each other, or units that are temporally adjacent to each other (such as one frame of image and the next frame of image).

TABLE 1

| Candidate unit | Index |
|---|---|
| first candidate unit | first index |
| second candidate unit | second index |
| third candidate unit | third index |

After generating the predictor, in step C01, the processor may determine whether the number of candidate units in the candidate unit list reaches the threshold number, wherein the threshold number indicates the number the data allowed to be recorded in the candidate unit list.

If the number of the candidate units in the candidate unit list reaches the threshold number, in step C03, the processor may delete at least one of the candidate units and the corresponding index, and record the reference 2D unit and the corresponding index generated in step A09 or B13 to the candidate unit list. The processor may select the candidate unit and the corresponding index to be deleted by performing rate—distortion optimization.

Take table 1 as an example, assuming the threshold number is five, the processor selects the candidate unit to be deleted is the third candidate unit and its index by performing rate— distortion optimization, the processor may delete the third candidate unit and its index, and add the index of the reference 2D unit 21/41 into the candidate unit list and at the same time the corresponding candidate predictor may be determined.

On the contrary, if the number of the candidate units in the candidate unit list does not reach the threshold number, in step C05, the processor may directly add the reference 2D unit 21/41 and its index into the candidate unit list and at the same time the corresponding candidate predictor may be determined.

In addition, the number of the candidate units in the candidate unit list reaches the threshold number, the processor may also skip performing step C01, expand the threshold number of the candidate unit list, and add the reference 2D unit 21/41 and its index into the candidate unit list and at the same time the corresponding candidate predictor may be determined. Subsequently, the processor may assign a flag to the reference 2D unit 21/41 and its index, wherein the flag is used to indicate the reference 2D unit 21/41 is a unit added through expanding the candidate unit list. Further, the processor may select a preferable candidate unit in the candidate unit list through performing rate—distortion optimization.

If the processor does not pre-store a candidate prediction list, the processor may establish the candidate unit list, and the candidate unit list records the reference 2D unit and its corresponding index generated in step A09 or B13.

The processor at the encoder site may transmit the index of one or more candidate unit of the candidate unit list to the processor at the decoder site after finishing the establishment or update of the candidate unit list, wherein the processor at the encoder site transmits the index of the preferable candidate unit selected through performing rate—distortion optimization to the processor at the decoder site.

In addition, the processor at the encoder site may output the selected the index of the preferable candidate unit and its corresponding residual to the processor at the decoder site, wherein the residual indicates a difference between the original image (the encoding unit 11/31) and the predicted image (the reference 2D unit 21/41).

Therefore, the processor at the decoder site may find the corresponding candidate unit from the candidate unit list established by the processor at the decoder according to the index of the preferable candidate unit transmitted by the processor at the encoder site, and determine the corresponding predictor. Accordingly, the processor at the decoder site may perform image reconstruction according to the determined predictor, the candidate unit and the residual received from the processor at the encoder site.

In addition, the embodiment of generating the candidate unit list may be performed by the processor at one of the encoder site and the decoder site. After generating the candidate unit list, the candidate unit list is transmitted to the processor from the encoder site to the decoder site. If the expansion of the threshold number of the candidate unit list is performed by the processor at the encoder site, the processor at the encoder site may further transmit the notification to the processor at the decoder site to notify the processor at the encoder site that the expanded candidate list may be reconstructed, and perform image reconstruction according to the index of the preferable candidate unit (and residual).

It should be noted that, as described above, except for the location coordinate, each unit and block may further include attribute coordinate such as the color components (R, G, B) or (Y, U, V). Therefore, when determining the relationships between the units to be decoded and the patches in images of other frames, the decoder may generate a better prediction result.

In view of the above description, according to one or more embodiments of the present disclosure of the method of generating point cloud predictor, the efficiency of the encoder and the decoder for searching the predicted unit that is the closest to the current encoding unit may be improved, and at the same time the amount of computation required for searching the predicted unit may be reduced and the time and complexity of decoding may be reduced. In addition, according to one or more embodiments of the present disclosure of the method of generating point cloud predictor, a more accurate predicted unit may be searched, and the temporal continuity of each patch between frames may be reconstructed when decoding.

What is claimed is:

1. A method of generating point cloud predictor, comprising:
obtaining an encoding unit; and
generating and outputting a predictor according to a variation degree between the encoding unit and a reference 2D unit.

2. The method of generating point cloud predictor according to claim 1, wherein after the step of obtaining the encoding unit, the method further comprises:
obtaining a current three-dimensional (3D) block in a current 3D image according to the encoding unit;
obtaining a reference 3D block in a reference 3D image according to the current 3D block; and
obtaining the reference 2D unit in a reference 2D image according to the reference 3D block;
wherein the encoding unit is generated from the current 3D image.

3. The method of generating point cloud predictor according to claim 2, wherein the encoding unit is located at a current 2D image generated from the current 3D image, and before obtaining the current 3D block, the method further comprises: obtaining a group of coordinate conversion parameters, wherein the group of coordinate conversion parameters records corresponding relationships between a plurality of blocks of the current 3D image and a plurality of units of the current 2D image, and obtaining the current 3D block in the current 3D image according to the encoding unit comprises:
determining one of the units of the group of coordinate conversion parameters corresponding to the encoding unit; and
using the block corresponding to the unit that the encoding unit corresponds to as the current 3D block.

4. The method of generating point cloud predictor according to claim 2, wherein obtaining the reference 2D unit in the reference 2D image according to the reference 3D block comprises:
enclosing a reference region at the reference 2D image, wherein the reference region includes a plurality of invalid units and a plurality of valid units;
obtaining a plurality of initial 3D blocks corresponding to the valid units in the reference 3D image according to an occupancy map; and
determining one of the initial 3D blocks that is the closest to the reference 3D block, and using a unit that the reference 3D block corresponds to in the reference 2D image as the reference 2D unit.

5. The method of generating point cloud predictor according to claim 2, wherein obtaining the reference 2D unit in the reference 2D image according to the reference 3D block comprises:
enclosing a reference region at the reference 2D image according to the reference 3D block, wherein the reference region includes a plurality of invalid units and a plurality of valid units;
obtaining a plurality of initial 3D blocks in the reference 3D image according to an occupancy map; and
determining one of the initial 3D blocks that is the closest to the reference 3D block, and using a unit that the reference 3D block corresponds to in the reference 2D image as the reference 2D unit.

6. The method of generating point cloud predictor according to claim 2, wherein after generating the predictor, the method further comprises:
determining whether a number of a plurality of candidate units in a candidate unit list reaches a threshold number;
when the number of the candidate units reaches the threshold number, deleting at least one of the candidate units, and recording the reference 2D unit to the candidate unit list; and
when the number of the candidate units not reaching the threshold number, recording the reference 2D unit to the candidate unit list.

7. The method of generating point cloud predictor according to claim 2, wherein after generating the predictor, the method further comprises:
recording the reference 2D unit to a candidate unit list, wherein the candidate unit list is configured to record a plurality of candidate units, wherein the candidate units comprise the reference 2D unit.

8. A method of generating point cloud predictor, comprising:
obtaining an encoding unit;
obtaining a first variation degree between a current projection box and a reference projection box according to the encoding unit;
obtaining a second variation degree between a current bounding box and a reference bounding box according to the encoding unit; and
outputting a predictor based on a sum of the first variation degree and the second variation degree.

9. The method of generating point cloud predictor according to claim 8, wherein after the step of obtaining the encoding unit, the method further comprising:
obtaining a current three-dimensional (3D) coordinate in a current 3D image according to the encoding unit;
enclosing the current bounding box in the current 3D image based on the current 3D coordinate, and projecting the current bounding box onto a projection plane to obtain the current projection box; and
enclosing the reference bounding box in a reference 3D image based on the current 3D coordinate, and projecting the reference bounding box onto the projection plane to obtain the reference projection box, wherein the reference 3D image is associated with the current 3D image;
wherein the encoding unit is generated from the current 3D image.

10. The method of generating point cloud predictor according to claim 9, wherein after generating the predictor, the method further comprising:
determining whether a number of a plurality of candidate units in a candidate unit list reaches a threshold number;
when the number of the candidate units reaches the threshold number, deleting at least one of the candidate units, and recording the reference projection box to the candidate unit list; and
when the number of the candidate units not reaching the threshold number, recording the reference projection box to the candidate unit list.

11. The method of generating point cloud predictor according to claim 9, wherein after generating the predictor, the method further comprising:
recording the reference projection box to a candidate unit list, wherein the candidate unit list is configured to record a plurality of candidate units, wherein the candidate units comprise the reference 2D unit.
